(19) United States
(12) Patent Application Publication
(10) Pub. No.: US 2006/0075907 A1
(43) Pub. Date: Apr. 13, 2006

(54) Juice maker feeding structure

(76) Inventor: Tony Hsu, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/959,150

(22) Filed: Oct. 7, 2004

(51) Int. Cl. B26D 1/00

(52) U.S. Cl. 99/511

(57) ABSTRACT

A juice maker feeding structure includes a feeding barrel and a stud, and is incorporated with a lid. The feeding barrel is connected with the lid. The feeding barrel is a hollow body having an inner wall. The stud is inserted into the feeding barrel. The inner wall of the feeding barrel is provided with a plurality of inclining guiding ribs. The stud has an outer wall formed with a plurality of recesses to accommodate the guiding ribs and a plurality of guiding bevels to facilitate insertion of the guiding ribs into the recesses. Each guiding bevel is formed from the bottom end of the stud upward to a respective recess.

### BACKGROUND OF THE INVENTION

1. Field of the Invention

This invention relates to a juice maker feeding structure. In particular, a stud spins in relation to a feeding barrel to push raw food downward.

2. Description of the Prior Art

A conventional juice maker feeding structure is to have a lid connected to a hollow feeding barrel. All chopped raw food or vegetables are stuffed in the feeding barrel and pushed downward by a stud. The feeding barrel is a straight and hollow body. The stud is a straight bar, corresponding to the hollow body of the feeding barrel, with a ring knob at the top end thereof.

The straight design of the stud may cause the pushing force unevenly.

### SUMMARY OF THE INVENTION

It is a primary advantage of the present invention to provide a juice maker feeding structure, which pushes the chopped vegetables to process evenly.

It is another advantage of the invention to provide a juice maker feeding structure, which is easy to operate.

It is a further advantage of the present invention to provide a juice maker feeding structure, which can squeeze the vegetables fully and entirely.

### BRIEF DESCRIPTION OF THE DRAWINGS

FIG. 1 is an exploded view of the present invention;

FIG. 2 is a cross-sectional view of the present invention; and

FIG. 3 is a cross-sectional view showing the operation of the present invention.

### DETAILED DESCRIPTION OF THE PREFERRED EMBODIMENT

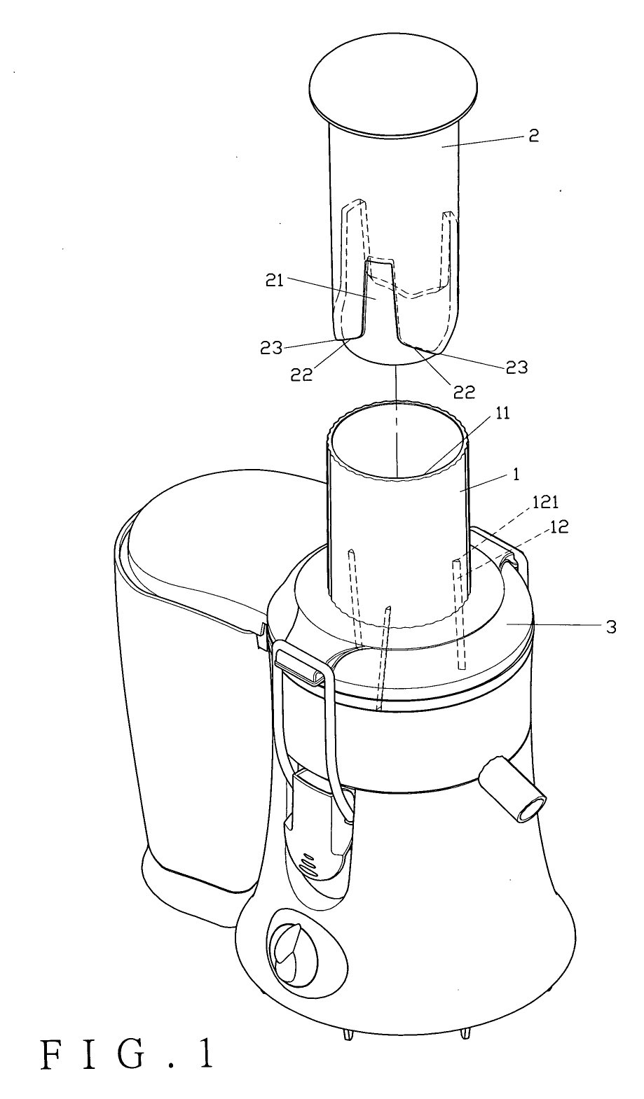

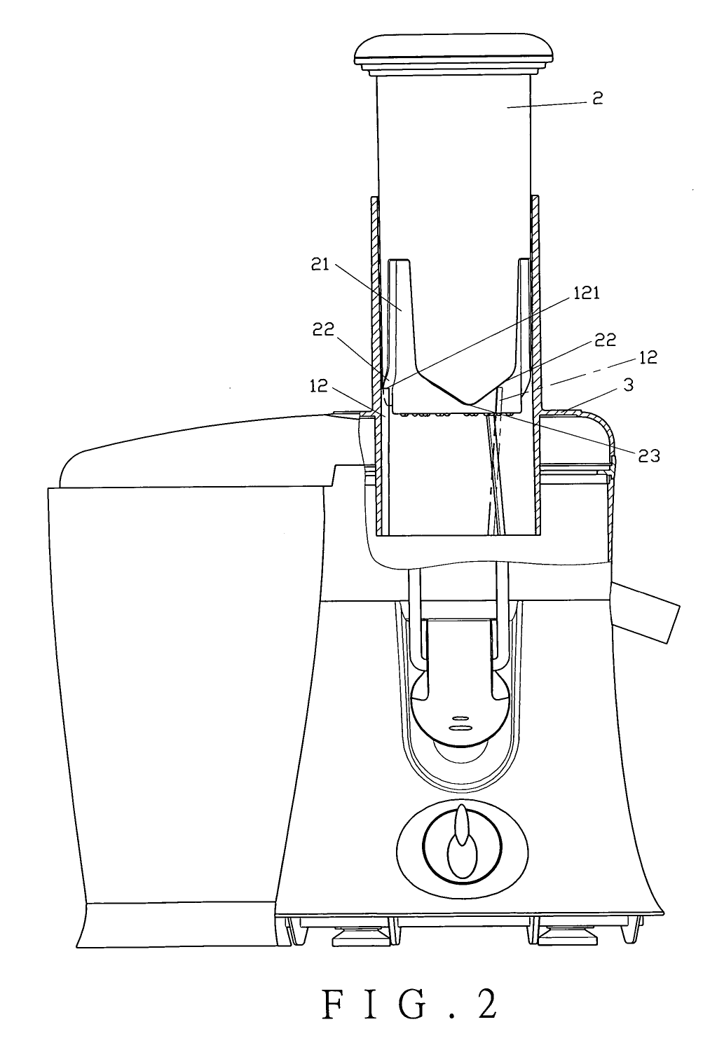

As shown in FIGS. 1 and 2, the present invention comprises a feeding barrel 1 and a stud 2, and is incorporated with a lid 3. The feeding barrel 1 is connected with the lid 3. The feeding barrel 1 is a hollow body having an inner wall 11. The stud 2 is inserted into the feeding barrel 1. The inner wall 11 of the feeding barrel 1 is provided with a plurality of inclining guiding ribs 12. The stud 2 has an outer wall formed with a plurality of recesses 21 to accommodate the guiding ribs 12 and a plurality of guiding bevels 22. Each guiding bevel 22 is formed from the bottom end 23 of the stud 2 upward to a respective recess 21. Each guiding rib 12 has a top end 121 in relation to a respective guiding bevel 22 to guide the guiding rib 12 into a respective recess 21.

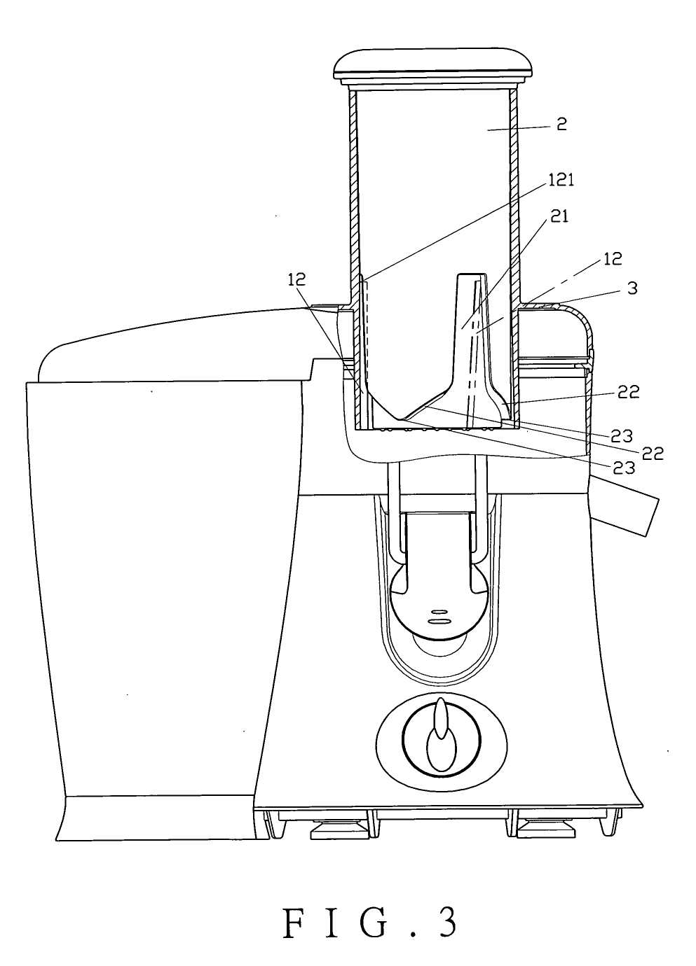

To operate the present invention, as shown in FIGS. 2 and 3, the stud 2 is inserted into the feeding barrel 1 and pushed inwardly. The bottom end 23 of the stud 2 engages with the top end 121 of each guiding rib 12. The top end 121 of each guiding rib 12 slides along a respective guiding bevel 22 into a respective recess 21. The stud 2 slides all the way to the bottom of the feeding barrel 1. Due to the guiding bevels 22, the stud 2 will move in a spinning manner downward, similar to the spin of a screw or a bolt, which provides an even and straight force.

I claim:

1. A juice maker feeding structure comprising a feeding barrel and a stud, and being incorporated with a lid, wherein said feeing barrel connected with said lid is a hollow body having an inner wall, and said stud is inserted into said feeding barrel, and characterized in that:
the inner wall of said feeding barrel comprising a plurality of guiding ribs, said stud having an outer wall formed with a plurality of recesses to accommodate said guiding ribs of said feeding barrel and a plurality of guiding bevels to facilitate insertion of said guiding ribs into said recesses.

2. The juice maker feeding structure, as recited in claim 1, wherein each guiding rib of said feeing barrel is in an inclining shape.

3. The juice maker feeding structure, as recited in claim 2, wherein each guiding bevel of said stud is formed from a bottom end of said stud upwardly to a respective recess.
